(19) United States
(12) Patent Application Publication
(10) Pub. No.: US 2025/0353478 A1
(43) Pub. Date: Nov. 20, 2025

(54) PARK BRAKE CONTROL SYSTEM

(71) Applicant: Deere & Company, Moline, IL (US)

(72) Inventors: MAHESH SOMAROWTHU, Pune (IN); SHRUTIKA UPASE, TULJAPUR (IN); Alexander R. Lowry, OTTUMWA, IA (US)

(21) Appl. No.: 18/668,309

(22) Filed: May 20, 2024

(51) Int. Cl. B60T 8/94; B60T 13/22

(52) U.S. Cl. CPC B60T 8/94; B60T 13/22; B60T 2270/413; B60Y 2200/222

(57) ABSTRACT

A hydraulic system of a windrower includes a hydraulic pressure source of a higher pressure hydraulic fluid and a hydraulic pressure return for receiving lower pressure hydraulic fluid. A parking brake is configured to be released by application of the higher pressure hydraulic fluid. A hydraulic fluid supply line is communicated with the parking brake. An electrically operated hydraulic fluid supply valve communicates the supply line with the hydraulic pressure source or with the hydraulic pressure return. An electrically operated selectable check valve is disposed in the supply line between the supply valve and the parking brake, the check valve being shiftable between a checking position permitting hydraulic fluid flow from the supply valve to the parking brake and preventing hydraulic fluid flow from the parking brake to the supply valve, and an open position communicating the supply valve with the parking brake.

### FIELD OF THE DISCLOSURE

The present disclosure relates to systems and methods for controlling the parking brakes of a self-propelled windrower or similar agricultural vehicle.

### BACKGROUND

The parking brakes of a windrower are typically constructed as spring applied hydraulic release brakes. With such a braking system hydraulic pressure must be provided to release the emergency brake so the vehicle can be operated. In the event of loss of hydraulic pressure, the emergency brake is automatically applied by the action of the mechanical spring. One difficulty encountered with such systems is that of maneuvering the vehicle in order to repair the vehicle after such a hydraulic failure.

### SUMMARY OF THE DISCLOSURE

The present disclosure provides a system for providing redundancy in the operability of the parking brakes of such a vehicle.

In one embodiment a self-propelled windrower includes a vehicle frame and a plurality of ground engaging units for supporting the vehicle frame from a ground surface, at least one of the ground engaging units being powered to drive the windrower. The hydraulic system of the vehicle includes a hydraulic pressure source of a higher pressure hydraulic fluid and a hydraulic pressure return for receiving lower pressure hydraulic fluid, the lower pressure hydraulic fluid being at a lower pressure than the higher pressure hydraulic fluid. A parking brake is configured to apply a braking force to at least one of the ground engaging units, the parking brake being configured to be released by application of the higher pressure hydraulic fluid to the parking brake. A hydraulic fluid supply line is communicated with the parking brake. An electrically operated hydraulic fluid supply valve is shiftable between a supply position communicating the supply line with the hydraulic pressure source, and a return position communicating the supply line with the hydraulic pressure return, the supply valve being configured to move to the return position upon loss of electrical power to the supply valve. An electrically operated selectable check valve is disposed in the supply line between the supply valve and the parking brake, the check valve being shiftable between a checking position permitting hydraulic fluid flow from the supply valve to the parking brake and preventing hydraulic fluid flow from the parking brake to the supply valve, and an open position communicating the supply valve with the parking brake, the check valve being configured to move to the open position upon loss of electrical power to the check valve.

In another embodiment, a method of providing redundant control of a parking brake of a self-propelled windrower like that described above is provided. The method includes in a primary operational control mode placing the check valve in its checking position and controlling operation of the parking brake by moving the supply valve between its supply position and return position.

Numerous objects, features and advantages of the present invention will be readily apparent to those skilled in the art upon a review of following description in conjunction with the accompanying drawings.

### BRIEF DESCRIPTION OF THE DRAWINGS

FIG. 1 is a schematic left front perspective view of an agricultural vehicle, in this example a windrower.

FIG. 2 is a schematic view of a portion of the hydraulic circuit of the vehicle of FIG. 1 relating to the parking brakes.

FIG. 3 is a schematic drawing of a control system of the vehicle of FIGS. 1 and 2.

### DETAILED DESCRIPTION

### The Agricultural Vehicle:

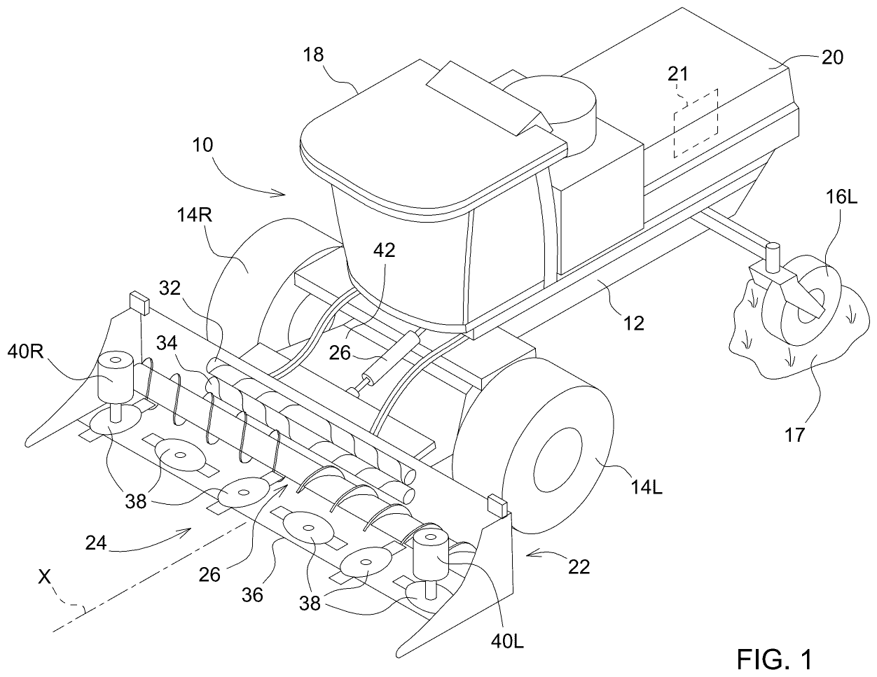

Referring to FIG. 1, a self-propelled agricultural vehicle 10 in the form of a mower, also referred to as a windrower, is operable to mow and collect standing crop in a field, condition the cut crop as it moves through the machine to improve its drying characteristics, and then return the conditioned material to the field in a windrow or swath. The windrower 10 includes a vehicle frame 12 supported on driven right and left front wheels 14R and 14L, respectively and on right and left caster mounted rear wheels, of which only a left rear wheel 16L is shown. The front and rear wheels 14 and 16 may collectively be referred to as a plurality of ground engaging units for supporting the vehicle frame 12 from a ground surface 17.

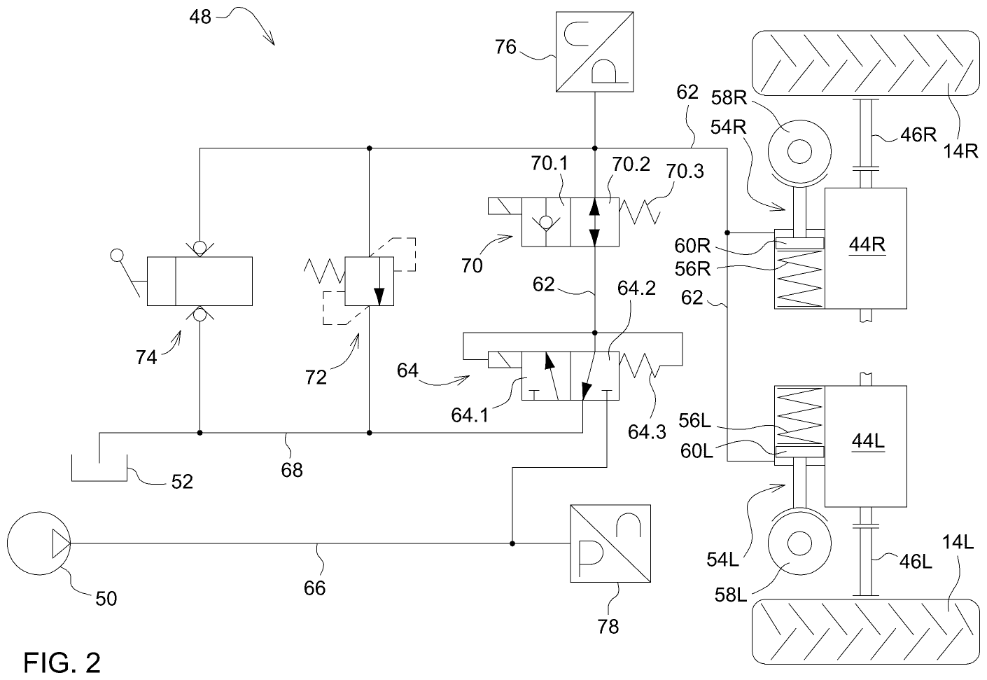

Carried on a forward end region of the frame 12 is a cab 18. Mounted on the frame 12 behind the cab 18 is a housing 20 within which is located a power source 21 such as an internal combustion engine 21. One or more of the front wheels 14L and 14R, preferably both, are powered to drive the vehicle 10. As schematically shown in FIG. 2, the front wheels 14L and 14R may be driven via hydraulic drive motors 44L and 44R driving axle shafts 46L and 46R. The hydraulic drive motors may be powered by hydraulic fluid provided from a hydraulic pump (not shown) powered by the internal combustion engine 21.

A harvesting header 22 is supported by the forward end of the frame 12. Operator controls (not shown) are provided in the cab 18 for operation of the mower-conditioner 10, including the attached harvesting header 22.

The harvesting header 22 could take many configurations but is here shown as including a rotary disc cutter bar 24 that delivers cut crop to a following crop converging auger 26 that delivers crop rearward into a discharge passage for further processing by a crop conditioning arrangement including upper and lower crop conditioner rolls 32 and 34, respectively. Conditioned crop is expelled to the rear by the conditioner rolls 32 and 34 and is formed into a windrow by upright right and left, windrow forming panels (not shown) which are supported by a top wall of an open-bottomed housing 42 located between the front wheels 14R and 14L.

The rotary disc cutter bar 24 includes an elongate gear housing 36 supporting a plurality of cutter discs 38 for rotation, with gearing (not shown) located within the housing 36 being arranged so that the cutter discs 38 located rightward of a longitudinal center line X are driven counterclockwise by a hydraulic fluid motor 40R coupled to the rightmost cutter disc 38, while the cutter discs 38 located leftward of the center line X are driven clockwise by a hydraulic fluid motor 40L coupled to the leftmost cutter disc 38.

### The Electro-Hydraulically Controlled Parking Brakes:

The internal combustion engine 21 may also provide hydraulic power to a hydraulic braking system 48 schematically shown in FIG. 2. Internal combustion engine 21 may drive a hydraulic pressure source 50 for providing a source of higher pressure hydraulic fluid. The hydraulic pressure source 50 may be a hydraulic pressure source pump 50 driven directly or indirectly by the internal combustion engine 21. The hydraulic braking system 48 may also include a hydraulic pressure return 52, which may sometimes be referred to as a tank 52. The hydraulic pressure return 52 is configured to receive lower pressure hydraulic fluid. The lower pressure hydraulic fluid returning to hydraulic pressure return 52 is at a lower pressure than the higher pressure hydraulic fluid provided by hydraulic pressure source 50.

The left and right front drive wheels 14L and 14R have associated therewith left and right parking brakes schematically shown as 54L and 54R in FIG. 2. Each of the parking brakes 54L and 54R is configured to apply a braking force to its respective wheel 14L, 14R.

Each of the parking brakes 54L, 54R may be configured as a spring applied hydraulic release parking brake. As schematically shown in FIG. 2 each of the parking brakes 54L, 54R includes a mechanical spring 56L, 56R configured to bias the parking brake into a braking position. This is accomplished by the spring applying a braking force to a component 58L, 58R associated with the drive of its respective wheel 14L, 14R. The component 58L, 58R may for example be a brake disc or brake drum mounted on the respective drive motor 44, shaft 46 or wheel 14. Each of the parking brakes 54L, 54R also includes a hydraulic piston 60L, 60R configured to be moved against the respective spring force to release the parking brake when sufficient hydraulic pressure is applied to the piston. In the absence of the higher pressure hydraulic fluid acting against the pistons 60L, 60R the springs 56L, 56R will apply the braking force to their respective wheels 14L, 14R.

A hydraulic fluid supply line 62 is communicated with the pistons 60L, 60R of the parking brakes 54L, 54R. An electrically operated hydraulic fluid supply valve 64 is shiftable between a supply position 64.1 communicating the supply line 62 with the hydraulic pressure source 50, and a return position 64.2 communicating the supply line 62 with the hydraulic pressure return 52. The supply valve 64 is configured to be moved to the return position 64.2 by a valve return spring 64.3 upon loss of electrical power to the supply valve 64.

Supply valve 64 is communicated with pressure source 50 by pressure supply line 66. Supply valve 64 is communicated with pressure return 52 by pressure return line 68.

An electrically operated selectable check valve 70 is disposed in the supply line 62 between the supply valve 64 and the parking brakes 54L, 54R. The check valve 70 is shiftable between a checking position 70.1 permitting hydraulic fluid flow from the supply valve 64 to the parking brakes 54L, 54R and preventing hydraulic fluid flow from the parking brakes 54L, 54R to the supply valve 64, and an open position 70.2 communicating the supply valve 64 with the parking brakes 54L, 54R. The check valve 70 is configured to be moved to the open position 70.2 by a valve return spring 74.3 upon loss of electrical power to the check valve 70.

When the electrically operated selectable check valve 70 is in the checking position 70.1 it is configured to at least temporarily trap the higher pressure hydraulic fluid against the parking brakes 54L, 54R to hold the parking brakes in a released position.

A pressure relief valve 72 communicates the supply line 62 with the return line 68 in the event of an unexpectedly high pressure in the supply line 62 exceeding a set relief value of the relief valve 72. A hand pump 74 provides the ability to manually increase the hydraulic pressure in supply line 62 to manually release the parking brakes 54L, 54R in the event of a hydraulic system failure.

A brake supply pressure sensor 76 is communicated with the supply line 62 between the check valve 70 and the parking brakes 541, 54R, and is configured to sense a hydraulic fluid pressure in the supply line 62.

A pressure source pressure sensor 78 is communicated with the pressure supply line 66 and is configured to sense a pressure of the higher pressure hydraulic fluid in the pressure supply line 66.

### The Control System:

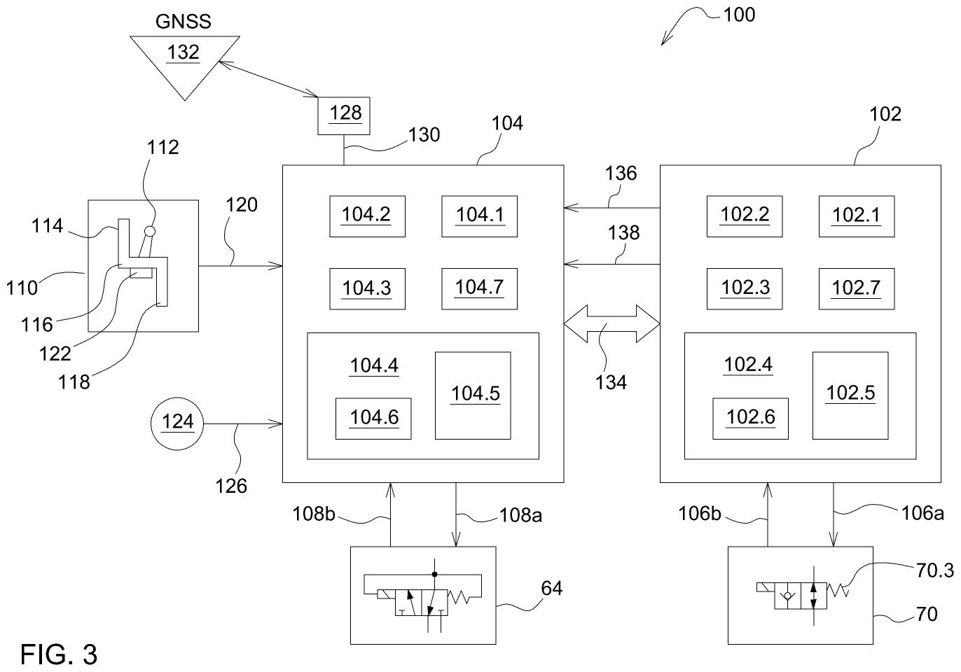

As schematically shown in FIG. 3 a control system 100 is provided to control the operation of the vehicle 10, including the operation of the hydraulic fluid supply valve 64 and the electrically operated selectable check valve 70 to control the operation of the parking brakes 54L, 54R. In one embodiment the control system 100 may include a master controller 102 and a slave controller 104. In an embodiment the master controller 102 may be a controller sometimes referred to as an SBBA Controller which controls steering, braking and other ancillary functions of the vehicle 10. In an embodiment the slave controller 104 may be a controller sometimes referred to as a Power Domain Controller which controls the engine functions of the internal combustion engine 21. Either of the controllers 102 or 104 may be a part of the machine control system of the vehicle 10 or it may be a separate control module.

In an embodiment as schematically shown in FIG. 3 the master controller 102 may be operably connected via communication lines 106a, 106b with the electrically operated selectable check valve 70 to selectably move the check valve 70 to the checking position 70.1. And as further shown in FIG. 3, the slave controller 102 may be operably connected to the hydraulic fluid supply valve 64 via communication lines 108a, 108b to control movement of the supply valve 64 between the supply position 64.1 and the return position 64.2.

The vehicle 10 may include an operator's input device 110 in the form of a shift lever 112 movable between a forward gate 114, a neutral gate 116 and a reverse gate 118. The input device 110 sends operational instructions to slave controller 104 via communication line 120. Placement of the shift lever 112 in the forward gate 114 instructs the slave controller 104 to move the vehicle 10 forward, and the position of the shift lever along the forward gate 114 instructs the slave controller as to the desired forward speed. Placement of the shift lever 112 in the reverse gate 118 instructs the slave controller 104 to move the vehicle 10 rearward, and the position of the shift lever along the reverse gate 118 instructs the slave controller as to the desired rearward speed. Placement of the shift lever 112 in the neutral gate 116 triggers a neutral position sensor 122 which sends a signal to the slave controller 104 indicating that the vehicle drive is in neutral.

A vehicle speed sensor 124 detects the actual advance speed of the vehicle 10 and sends a vehicle speed signal 126 to the slave controller 104. The vehicle speed sensor 124 may for example be a wheel based vehicle speed sensor 124 which detects the rotational speed of one of the wheels 44L or 44R.

One or more vehicle positioning sensors 128 may provide a vehicle position signal 130 to either the master controller 102 or slave controller 104. The vehicle position sensors 128 may for example be receivers for signals from a satellite based positioning system 132 such as the global GNSS system or GPS system. The vehicle position sensors could also be associated with a land based positioning system such as a Total system or a laser based positioning system. The use of position sensors 128 allows the control system 100 to store information regarding the geographic location of the machine 10 at the time of equipment failure.

The following is a detailed description of the master controller 102. The slave controller 104 may be constructed in a similar manner. The master controller 102 may include or may be associated with a processor 102.1, a computer readable medium 102.2, a database 102.3 and an input/output module or control panel 102.4 having the a display 102.5. An input/output device 102.6, such as a keyboard, joystick or other user interface, is provided so that the human operator may input instructions to the controller. It is understood that the master controller 102 described herein may be a single controller having all of the described functionality, or it may include multiple controllers wherein the described functionality is distributed among the multiple controllers.

Various operations, steps or algorithms as described in connection with the master controller 102 can be embodied directly in hardware, in a computer program product 102.7 such as a software module executed by the processor 102.1, or in a combination of the two. The computer program product 102.7 can reside in RAM memory, flash memory, ROM memory, EPROM memory, EEPROM memory, registers, hard disk, a removable disk, or any other form of computer-readable medium 102.2 known in the art. An exemplary computer-readable medium 102.2 can be coupled to the processor 102.1 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The data storage in computer readable medium 102.2 and/or database 102.3 may in certain embodiments include a database service, cloud databases, or the like. In various embodiments, the computing network may comprise a cloud server, and may in some implementations be part of a cloud application wherein various functions as disclosed herein are distributed in nature between the computing network and other distributed computing devices. Any or all of the distributed computing devices may be implemented as at least one of an onboard vehicle controller, a server device, a desktop computer, a laptop computer, a smart phone, or any other electronic device capable of executing instructions. A processor (such as a microprocessor) of the devices may be a generic hardware processor, a special-purpose hardware processor, or a combination thereof.

The slave controller 104 may be similarly constructed and may include a processor 104.1, a computer readable medium 104.2, a database 104.3, a control panel 104.4, a display 104.5, an input/output device 104.6 and a computer program product 104.7.

### Modes of Operation:

### Primary Operational Control Mode:

The master controller 102 and slave controller 104 may communicate with each other over a communications bus 134 or other communication system. With regard to the operation of the parking brakes 54L, 54R the master controller 102 may be configured via the computer program product 102.7 to provide a primary operational control mode for operation of the parking brakes during normal operation of the vehicle 10 when both controllers 102 and 104 and the hydraulic fluid supply valve 64 and the electrically operated selectable check valve 70 are all functioning properly.

As is further described below, the use of two valves 64 and 70 and the two controllers 102 and 104 provides various modes of operational redundance which will reduce unnecessary application of the parking brakes 54L, 54R, and which will also allow the operator to still have limited control of the parking brakes in the event of various events of equipment failure.

In the primary operational control mode the master controller 102 generates command signals 136 to the slave controller 104 to in turn generate command signals 108a from the slave controller 104 to the hydraulic fluid supply valve 64 to apply and release the parking brakes 54L, 54R as desired by moving the hydraulic fluid supply valve 64 between its supply position 64.1 to release the parking brakes and its return position 64.2 to apply the parking brakes.

If it is desired that the parking brakes 54L, 54R be held in their applied position by the springs 56L, 56R, the master controller directs the electrically operated selectable check valve 70 to move the check valve 70 to its open position 70.2, and the master controller 102 directs the slave controller 104 to direct the hydraulic fluid supply valve 64 to move to the return position 64.2 so that the supply line 62 is open to the return line 68 thus releasing hydraulic pressure from the pistons 60L, 60R.

If it is desired that the parking brakes 54L, 54R be held in their release position by application of higher pressure hydraulic fluid against the pistons 60L, 60R, the master controller 102 energizes the electrically operated selectable check valve 70 to move the check valve 70 to its checking position 70.1, and the master controller 102 directs the slave controller 104 to direct the hydraulic fluid supply valve 64 to move to the supply position 64.1 so that higher pressure hydraulic fluid is directed through the supply line 62 to the parking brakes 54L, 54R to hold the parking brakes in the released position.

The presence of the electrically operated selectable check valve 70 provides a safeguard against unnecessary or premature application of the parking brakes 54L, 54R in the event of a failure of the slave controller 104 or a failure of the hydraulic fluid supply valve 64. If while the parking brakes 54L, 54R are held in their release position as described above, there is a failure of the slave controller 104 or of the hydraulic fluid supply valve 64, the electrically operated selectable check valve 70 in its checking position 70.1 will at least temporarily trap the higher pressure hydraulic fluid against the parking brakes 54L, 54R to hold the parking brakes 54L, 54R in their released position.

The control system 100 may provide a visual, audible or tactile notification to the operator of the vehicle 10 informing the operator of the nature of the equipment failure. The operator of the vehicle 10 may then move the vehicle 10 to a suitable location to effect repairs of the vehicle 10. The operator may then apply the parking brakes via the Manual Parking Brake Control Mode or the Automatic Parking Brake Control Mode as is further described below.

### Standby Redundancy Mode:

The slave controller 104 may further be configured to provide a standby redundancy mode of operation of the parking brakes 54L, 54R in the event of failure of the master controller 102. The master controller 102 may be configured to provide a periodic heartbeat signal 138 to the slave controller 104 to confirm to the slave controller 104 the operability of the master controller 102. For example the heartbeat signal 138 may be communicated every 40 msec, toggling every 80 msec. The timeouts are configurable and the toggle rate is adjustable. The signal may be communicated over CAN communication, but is not so limited. The following table shows the state of the heartbeat signal for each possible state of the signal:

| Heartbeat Signal | Heartbeat Status |
|---|---|
| A bit in the signal will toggle between | Toggling |
| Active and Not Active at a set | |
| interval of Heartbeat Stopped Toggling | |
| Timeout | |
| The signal with toggling bit is not | Not Toggling |
| received or the signal is received but the | |
| bit does not toggle as expected - | |
| Heartbeat Stopped Toggling Timeout | |
| elapsed. | |
| Error | Not Toggling |
| Not Available | Not Toggling |

The slave controller 104 may further be configured to implement the standby redundancy mode of operation in the event of the loss of the heartbeat signal 138 indicating failure of the master controller 102. The slave controller 104 may be configured in the standby redundance mode of operation to allow an operator of the vehicle 10 to manually direct application of the parking brakes 54L, 54R at least once after failure of the master controller 102.

In the event of failure of the master controller 102 the energizing signal 106a to the electrically operated selectable check valve 70 is lost so that the check valve 70 is moved by action of its internal biasing spring 70.3 to the open position 70.2. The slave controller 104 may continue to apply or release the brakes 54L, 54R by moving the hydraulic fluid supply valve 64 between its return and supply positions 64.2 and 64.1. In this standby redundancy mode of operation of the slave controller 104 the actions of the slave controller 104 may be controlled by programming contained in the computer program product 104.7 of the slave controller 104.

### Manual Parking Brake Control Mode:

The master controller 102 and/or the slave controller 104 may each be configured to provide a manual parking brake control mode in which the parking brakes 54L, 54R are communicated with the hydraulic pressure return 52 so that the parking brakes 54L, 54R apply a braking force to the wheels 14L, 14R via the mechanical springs 56L, 56R in response to a manual input from an operator of the vehicle 10.

For example the operator of the vehicle 10 may input a manual command to master controller 102 via the input/output device 102.6 which may be in the form of a push button. In response to that manual command the manual parking brake control mode which is programmed into the computer program product 102.7 may direct the electrically operated selectable check valve 70 to move to its open position 70.2, and the manual parking brake control mode may direct the slave controller 104 to direct the hydraulic fluid supply valve 64 to move to its return position 64.2 to release hydraulic pressure from the parking brakes 54L, 54R so that the mechanical springs 56L, 56R can move the brakes to their applied position.

Similarly, if the manual parking brake control mode is embodied in the slave controller 104, the operator of the vehicle 10 may input a manual command to master controller 104 via the input/output device 104.6 which may be in the form of a push button. In response to that manual command the manual parking brake control mode which is programmed into the computer program product 104.7 may direct the electrically operated selectable check valve 70 to move to its open position 70.2, and the manual parking brake control mode may direct the slave controller 104 to direct the hydraulic fluid supply valve 64 to move to its return position 64.2 to release hydraulic pressure from the parking brakes 54L, 54R so that the mechanical springs 56L, 56R can move the brakes to their applied position.

### Automatic Parking Brake Control Mode:

The master controller 102 and/or the slave controller 104 may be configured to provide an automatic parking brake control mode in which movement of the supply valve 64 between the supply position 64.1 and the return position 64.2 to release or apply the parking brakes 54L, 54R is automatically controlled in response to a position of the operator's input device 110.

If the shift lever 112 is located in either the forward gate 114 or the reverse gate 118 indicating that the vehicle 10 is driving forward or rearward, the automatic parking brake control mode of the master controller 102 may hold the parking brakes 54L, 54R in the released position so that the vehicle 10 may move. This may be accomplished by moving the supply valve 64 to its supply position 64.1. The check valve 70 may be in either position, but is preferably in its checking position 70.1.

If the shift lever 112 is moved to the neutral gate 116 the neutral sensor 122 may send a signal via communication line 120 to the slave controller 104 which may relay the signal to the master controller 102 indicating that the vehicle 10 is in neutral and the parking brakes 56L, 56R should be automatically applied. This may be accomplished by moving the supply valve 64 to its return position 64.2 and moving the check valve 70 to its open position 70.2.

The operator of the vehicle 10 may select whether the parking brakes are in the manual parking brake control mode or the automatic parking brake control mode by a manual input to either the input/output device 102.6 of the master controller 102 the input/output device 104.6 of the slave controller 104. That input/output device may be in the form of a push button. An accompanying indicator light or other visual indica on the display 102.5 or 104.5 may indicate to the operator which mode has been selected.

### Tow Mode of Operation:

The master controller 102 may be further configured to provide a tow mode of operation in which the parking brakes 54L, 54R are released in response to a manual input from an operator of the vehicle 10. For example, if the vehicle 10 is disabled and has a complete loss of power, the check valve 70 will default to its open position 70.2 and the supply valve 64 will default to is return position 64.2, thus relieving hydraulic pressure from the parking brakes and allowing the spring members 56L, 56R to apply the parking brakes. In order to then tow the vehicle 10 to another location for repair, it is necessary to somehow release the parking brakes.

For example, the check valve 70 could be moved to its checking position 70.1 and then pressure could be applied to release the parking brakes by use of the manual pump 74. Or an external hydraulic pressure supply could be applied to the supply line 62.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1: A self-propelled windrower, comprising:
a vehicle frame;
a plurality of ground engaging units for supporting the vehicle frame from a ground surface, at least one of the ground engaging units being powered to drive the windrower;
a hydraulic pressure source of higher pressure hydraulic fluid;
a hydraulic pressure return for receiving lower pressure hydraulic fluid, the lower pressure hydraulic fluid being at a lower pressure than the higher pressure hydraulic fluid;
a parking brake configured to apply a braking force to at least one of the ground engaging units, the parking brake being configured to be released by application of the higher pressure hydraulic fluid to the parking brake;
a hydraulic fluid supply line communicated with the parking brake;
an electrically operated hydraulic fluid supply valve shiftable between a supply position communicating the supply line with the hydraulic pressure source, and a return position communicating the supply line with the hydraulic pressure return, the supply valve being configured to move to the return position upon loss of electrical power to the supply valve; and
an electrically operated selectable check valve disposed in the supply line between the supply valve and the parking brake, the check valve being shiftable between a checking position permitting hydraulic fluid flow from the supply valve to the parking brake and preventing hydraulic fluid flow from the parking brake to the supply valve, and an open position communicating the supply valve with the parking brake, the check valve being configured to move to the open position upon loss of electrical power to the check valve.

2: The self-propelled windrower of claim 1, further comprising:
a master controller operably connected to the check valve and configured to move the check valve to the checking position during an operating mode of the windrower; and
a slave controller operably connected to the supply valve and configured to control movement of the supply valve between the supply position and the return position during the operating mode of the windrower.

3: The self-propelled windrower of claim 2, wherein:
the master controller is configured to provide a primary operational control mode of the parking brake in which the master controller generates command signals to the slave controller to in turn generate command signals from the slave controller to the supply valve to apply and release the parking brake during the primary operational control mode.

4: The self-propelled windrower of claim 3, wherein:
the master controller is configured to provide a periodic heartbeat signal to the slave controller to confirm operability of the master controller; and
wherein the slave controller is configured to provide a standby redundancy mode of operation of the parking brake in the event of loss of the heartbeat signal indicating failure of the master controller, the standby redundancy mode of operation allowing an operator of the windrower to manually direct application of the parking brake at least once after failure of the master controller.

5: The self-propelled windrower of claim 2, wherein:
the checking position of the check valve is configured to at least temporarily trap the higher pressure hydraulic fluid against the parking brake to hold the parking brake in a released position in the event of operational failure of the slave controller.

6: The self-propelled windrower of claim 2, wherein:
the master controller and/or the slave controller is configured to provide a manual parking brake control mode in which the parking brake is communicated with the hydraulic pressure return so that the parking brake applies the braking force in response to a manual input from an operator of the windrower.

7: The self-propelled windrower of claim 2, wherein:
the master controller and/or the slave controller is configured to provide an automatic parking brake control mode in which movement of the supply valve between the supply position and the return position to release or apply the parking brake is automatically controlled in response to a position of an operator's input device configured to direct forward and rearward movement of the windrower.

8: The self-propelled windrower of claim 2, wherein:
the master controller and/or the slave controller is configured to provide a tow mode of operation in which the parking brake is released in response to a manual input from an operator of the windrower.

9: The self-propelled windrower of claim 1, further comprising:
a brake supply pressure sensor configured to sense a hydraulic fluid pressure in the supply line between the check valve and the parking brake.

10: The self-propelled windrower of claim 1, wherein:
the parking brake is a spring applied hydraulic release parking brake including a mechanical spring configured to apply the braking force to the at least one ground engaging unit in the absence of the application of the higher pressure hydraulic fluid to the parking brake.

11: The self-propelled windrower of claim 1, wherein:
the checking position of the check valve is configured to at least temporarily trap the higher pressure hydraulic fluid against the parking brake to hold the parking brake in a released position in the event of operational failure of the supply valve.

12: The self-propelled windrower of claim 1, wherein:
the at least one of the ground engaging units being powered to drive the windrower includes two hydraulically powered front drive wheels.

13: A method of providing redundant control of a parking brake of a self-propelled windrower, the windrower including:
a vehicle frame;
a plurality of ground engaging units for supporting the vehicle frame from a ground surface, at least one of the ground engaging units being powered to drive the windrower;
a hydraulic pressure source of higher pressure hydraulic fluid;
a hydraulic pressure return for receiving lower pressure hydraulic fluid, the lower pressure hydraulic fluid being at a lower pressure than the higher pressure hydraulic fluid;
a parking brake configured to apply a braking force to at least one of the ground engaging units, the parking brake being configured to be released by application of the higher pressure hydraulic fluid to the parking brake;
a hydraulic fluid supply line communicated with the parking brake;
an electrically operated hydraulic fluid supply valve shiftable between a supply position communicating the supply line with the hydraulic pressure source, and a return position communicating the supply line with the hydraulic pressure return; and
an electrically operated selectable check valve disposed in the supply line between the supply valve and the parking brake, the check valve being shiftable between a checking position permitting hydraulic fluid flow from the supply valve to the parking brake and preventing hydraulic fluid flow from the parking brake to the supply valve, and an open position communicating the supply valve with the parking brake;
wherein the method comprises:
in a primary operational control mode placing the check valve in its checking position and controlling operation of the parking brake by moving the supply valve between its supply position and return position.

14: The method of claim 13, further comprising:
in an event of a failure of the slave controller or the supply valve, at least temporarily trapping the higher hydraulic fluid pressure against the parking brake with the checking position of the check valve to hold the parking brake in a released position.

15: The method of claim 13, further comprising:
in an event of a failure of the master controller or the check valve, automatically returning the check valve to its open position by action of a valve return spring of the check valve; and
continuing to control operation of the parking brake by moving the supply valve between its supply position and return position.

16: The method of claim 15, further comprising:
providing a periodic heartbeat signal from the master controller to the slave controller to confirm to the slave controller the operability of the master controller; and
detecting the failure of the master controller by detecting loss of the periodic heartbeat signal from the master controller to the slave controller.

17: The method of claim 16, further comprising:
in the event of loss of the heartbeat signal indicating failure of the master controller, providing with the slave controller a standby redundancy mode of operation allowing the operator of the windrower to manually direct application of the parking brake at least once after failure of the master controller.

18: The method of claim 13, further comprising:
providing a manual parking brake control mode in which the parking brake is communicated with the hydraulic pressure return so that the parking brake applies the braking force in response to a manual input from an operator of the windrower.

19: The method of claim 13, further comprising:
providing an automatic parking brake control mode in which movement of the supply valve between the supply position and the return position to release or apply the parking brake is automatically controlled in response to a position of an operator's input device configured to direct forward and rearward movement of the windrower.
